(19) United States
(12) Patent Application Publication
(10) Pub. No.: US 2016/0043824 A1
(43) Pub. Date: Feb. 11, 2016

(54) SEGMENTED DATA-AIDED FREQUENCY ESTIMATION IN TD-SCDMA

(71) Applicant: QUALCOMM Incorporated, San Diego, CA (US)

(72) Inventors: Insung Kang, San Diego, CA (US); Andreja Radosevic, San Diego, CA (US); Surendra Boppana, San Diego, CA (US); Vinay Praneeth Boda, Hyattsville, MD (US); Pouya Tehrani, San Diego, CA (US)

(21) Appl. No.: 14/456,493

(22) Filed: Aug. 11, 2014

(51) Int. Cl. H04J 3/16; H04W 72/04; H04J 13/00

(52) U.S. Cl. CPC H04J 3/1694; H04J 13/0003; H04W 72/0453; H04W 72/0446

(57) ABSTRACT

Apparatus, methods, and computer program product for data-aided frequency estimation in time division synchronous code division multiple access (TD-SCDMA) include receiving, in a downlink time slot of a TD-SCDMA network, a first data burst before a midamble, the midamble, and a second data burst after the midamble; determining at least one data segment that includes symbols in one or both of the first data burst and the second data burst, where the at least one data segment includes a data segment with fewer symbols than a union of the first data burst and the second data burst; and determining a frequency estimate based on the data segment.

### BACKGROUND

Aspects of the present disclosure relate generally to wireless communication systems, and more particularly, to segmented data-aided frequency estimation in Time Division-Synchronous Code Division Multiple Access (TD-SCDMA).

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, in some countries like China, TD-SCDMA is being considered as the underlying air interface in the UTRAN architecture with existing GSM infrastructure as the core network. The UMTS also supports enhanced 3G data communications protocols, such as High Speed Downlink Packet Data (HSDPA), which provides higher data transfer speeds and capacity to associated UMTS networks.

Conventionally, in TD-SCDMA, a data-aided frequency tracking loop (FTL) performs frequency estimation based on all 44 data symbols transmitted in a TD-SCDMA downlink time slot (e.g., 22 data symbols in a first data burst before a midamble and 22 data symbols in a second data burst after the midamble). Such conventional data-aided FTLs perform frequency estimation under the assumption that hard decisions made on all 44 data symbols in a TD-SCDMA downlink time slot are correct. However, there may be large frequency offsets affecting the data symbols that are located away from the midamble of a TD-SCDMA downlink time slot, thereby limiting the pulling range of the conventional data-aided FTL to, for example, ˜500 Hz. Such limited pulling range may cause performance degradation in high-mobility channel model scenarios, for example, in channel models corresponding to wireless communication on moving vehicles, such as automobiles, planes, or high-speed trains.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method is provided for data-aided frequency estimation in time division synchronous code division multiple access (TD-SCDMA), including receiving, in a downlink time slot of a TD-SCDMA network, a first data burst before a midamble, the midamble, and a second data burst after the midamble; determining at least one data segment that includes data symbols in one or both of the first data burst and the second data burst, where the at least one data segment includes a data segment with fewer symbols than a union of the first data burst and the second data burst; and determining a frequency estimate based on the data segment.

In another aspect, an apparatus is provided for data-aided frequency estimation in TD-SCDMA, including a receiver configured to receive, in a downlink time slot of a TD-SCDMA network, a first data burst before a midamble, the midamble, and a second data burst after the midamble; a data segmenting component configured to determine at least one data segment that includes data symbols in one or both of the first data burst and the second data burst, where the at least one data segment includes a data segment with fewer symbols than a union of the first data burst and the second data burst; and a frequency estimator component configured to determine a frequency estimate based on the data segment.

In a further aspect, an apparatus is provided for data-aided frequency estimation in TD-SCDMA, including means for receiving, in a downlink time slot of a TD-SCDMA network, a first data burst before a midamble, the midamble, and a second data burst after the midamble; means for determining at least one data segment that includes data symbols in one or both of the first data burst and the second data burst, where the at least one data segment includes a data segment with fewer symbols than a union of the first data burst and the second data burst; and means for determining a frequency estimate based on the data segment.

In yet another aspect, a computer-readable medium storing computer executable code is provided for data-aided frequency estimation in TD-SCDMA, including code for receiving, in a downlink time slot of a TD-SCDMA network, a first data burst before a midamble, the midamble, and a second data burst after the midamble; code for determining at least one data segment that includes data symbols in one or both of the first data burst and the second data burst, where the at least one data segment includes a data segment with fewer symbols than a union of the first data burst and the second data burst; and code for determining a frequency estimate based on the data segment.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, where an element represented with dashed lines may indicate an optional element, and in which:

FIG. 1 is a diagram illustrating an example of a wireless communications system according to some present aspects;

FIG. 2 is a diagram illustrating example data segments in a downlink time division synchronous code division multiple access (TD-SCDMA) time slot according to some present aspects;

FIGS. 3 and 4 are flow charts of example methods of wireless communication in aspects of the wireless communications system of FIG. 1;

FIG. 5 is a diagram of a hardware implementation for an apparatus employing a processing system, including aspects of the wireless communications system of FIG. 1;

FIG. 6 is a diagram illustrating an example of a telecommunications system, including aspects of the wireless communications system of FIG. 1;

FIG. 7 is a diagram illustrating an example of a frame structure in a telecommunications system, in aspects of the wireless communications system of FIG. 1; and

FIG. 8 is a diagram illustrating an example of a Node B in communication with a UE in a telecommunications system, including aspects of the wireless communications system of FIG. 1.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known components are shown in block diagram form in order to avoid obscuring such concepts.

As used herein, a frequency tracking loop (FTL) performs frequency estimation on the received signals received at a device so that such frequency estimates may be used to compensate for frequency offsets of the received signals. For example, when the received signals are modulated onto a carrier, there may be a need for carrier synchronization at the device and the device may compensate for any frequency offsets incurred on the carrier frequency in order to perform demodulation on the received signals. An FTL may be implemented, for example, as one or more processor modules in a processor of a device, as computer-readable instructions stored in a computer-readable medium in a memory of a device and executed by a processor of the device, or some combination of both. For example, in an aspect, the device may be a user equipment (UE) or other mobile communication device, and the signals may be wireless signals transmitted by a network entity, such as a base station, or transmitted by any other wireless communication device.

As used herein, a data-aided FTL is an FTL that performs frequency estimation based on demodulated data symbols.

As used herein, a pulling range of an FTL is the maximum frequency offset that the FTL can estimate and compensate for. That is, a frequency offset beyond the pulling range of an FTL cannot be properly estimated by the FTL, and therefore, cannot be properly compensated for.

Some present aspects provide improved frequency estimation in Time Division-Synchronous Code Division Multiple Access (TD-SCDMA). In some aspects, the pulling range of a data-aided frequency tracking loop (FTL) is improved by performing frequency estimation while accounting for the reliability of data symbol detection decisions, where the reliability of such data symbol detection decisions may decrease with the distance of data symbols from the midamble of the sub-frame. Accordingly, in some present aspects, data-aided frequency estimation may be performed based on data segments (e.g., a set of data symbols) in a TD-SCDMA sub-frame, and a frequency estimate may be determined as a function of different frequency estimates obtained based on different data segments, where such function may be based on relative reliability of data symbol detection decisions in each data segment. Further, in some alternative or additional aspects, a frequency estimate may be determined as a function of different frequency estimates obtained based on different data segments, where such function may be based on the estimated signal to noise ratio (SNR) of each data segment.

For example, in one present non-limiting example aspect, each of the two data bursts before and after a midamble of a TD-SCDMA sub-frame may be divided into one or more data segments which may have different lengths. Then, data-aided frequency estimation may be performed separately based on each data segment, and a frequency estimate may be determined as a weighted average of frequency estimates obtained based on different data segments. In some aspects, for example, in determining the weighted average of frequency estimates corresponding to different data segments, the data segments that are closer to the midamble may be given a higher weight compared to the data segments that are farther away from the midamble. In some alternative or additional aspects, for example, in determining the weighted average of frequency estimates corresponding to different data segments, the data segments that have a higher estimated SNR may be given a higher weight compared to the data segments that have a lower estimated SNR.

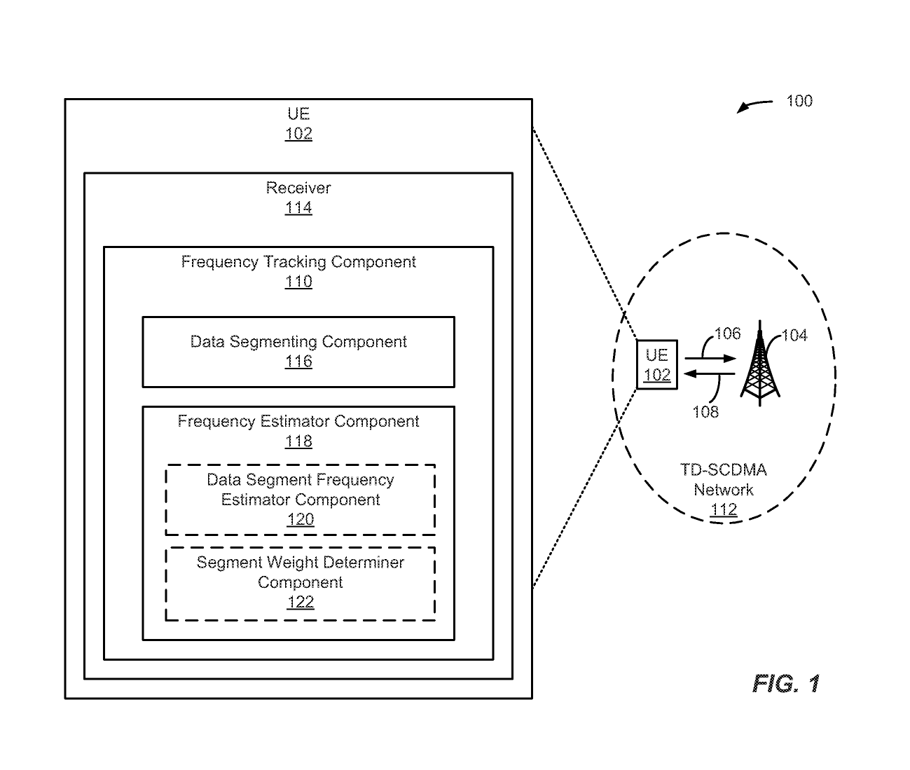

Referring to FIG. 1, a wireless communications system 100 includes an aspect of a frequency tracking component 110 configured to improve frequency estimation in TD-SCDMA network 112. Wireless communications system 100 includes user equipment (UE) 102 that is receiving downlink signals 108 from base station 104 and transmitting uplink signals 106 to base station 104 in TD-SCDMA network 112. In some aspects, the term “component” as used herein may be one of the parts that make up a system, may be hardware or software, and may be divided into other components.

Conventionally, in TD-SCDMA network 112, the chip rate is 1.28 megachips per second (Mcps) and the downlink time slot is 675 microseconds (μs) or 874 chips. Table 1 shows an example configuration of chips in a TD-SCDMA downlink time slot.

TABLE 1
An example configuration of chips in a TD-SCDMA downlink time slot

| | | | |
|---|---|---|---|
| Data (352 | Midamble (144 chips) | Data (352 chips) | GP (16 chips) |
| chips) | | | |

As shown in Table 1, there are 144 chips in the midamble of a TD-SCDMA downlink time slot. The midambles are training sequences for channel estimation and power measurements at UE 102. Each midamble can potentially have its own beamforming weights. Also, there is no offset between the power of the midamble and the total power of the associated channelization codes. The TD-SCDMA downlink time slot further includes 704 data chips and 16 guard period (GP) chips.

Conventionally, UE 102 may perform frequency estimation based on all 44 data symbols transmitted in a TD-SCDMA downlink time slot (e.g., 22 data symbols in a first data burst before a midamble and 22 data symbols in a second data burst after the midamble). For example, in some aspects, UE 102 may include receiver 114 that receives downlink signals 108 wirelessly transmitted from base station 104 and executes a data-aided frequency tracking loop (FTL) to perform frequency estimation based on all 44 data symbols transmitted in a TD-SCDMA downlink time slot. Such conventional data-aided FTL performs frequency estimation under the assumption that hard detection decisions (e.g., detection decisions resulting in a bit value or two distinct levels, as opposed to soft detection decisions that indicate a likelihood of a bit value) made on all 44 data symbols in a TD-SCDMA downlink time slot are correct.

However, there may be large frequency offsets affecting the data symbols that are located away from the midamble of a TD-SCDMA downlink time slot, thereby limiting the pulling range of the conventional data-aided FTL to, for example, ˜500 Hz. Such limited pulling range may cause performance degradation in high-mobility channel model scenarios, for example, in channel models corresponding to wireless communication on moving vehicles, such as but not limited to airplanes or high-speed trains travelling at a high speed, e.g., near or above 400 Km/hr.

In some present aspects, however, receiver 114 of UE 102 includes frequency tracking component 110 that operates to address one or more of the above-noted deficiencies of conventional receivers in TD-SCDMA by performing frequency estimation while accounting for the reliability of data symbol detection decisions. Although frequency tracking component 110 is illustrated as a part of receiver 114, it should be understood that frequency tracking component 110 may be separate from, but in communication with, receiver 114. For instance, frequency tracking component 110 may be implemented as one or more processor modules in a processor of UE 102, as computer-readable instructions stored in a memory of UE 102 and executed by a processor of UE 102, or some combination of both.

In some aspects, for example, UE 102 and/or receiver 114 receive and process downlink signals 108. In these aspects, a received symbol yₖ after equalization (which may be performed by receiver 114 and/or UE 102) may be modeled as:

yₖ=e^{j2πfk}xₖ+wₖ

where k is the symbol index, j is the unit imaginary number, xₖ is the transmitted modulation symbol, wₖ is white noise, and f is the normalized frequency offset. In some aspects, due to the presence of midamble symbols in the middle of the two data bursts (e.g., a first data burst, DB1, before the midamble and a second data burst, DB2, after the midamble), such model of yₖ is valid for:
kε[−26:−5] U [5:26]
Spreading Factor=16
   where U denotes union and [a:b] is the set of integer numbers from a to b and including a and b. Further, in these aspects, the exponential term e^{j2πfk} in yₖ grows in both sides of the midamble (kε[−26:−5] and kε[5:26]), resulting in large rotation in hard detection decisions made on data symbols that are far from the midamble. For example, in some aspects, there may be rapid changes in the frequency offset when UE 102 is on a high speed train travelling at a speed near or above, e.g., 400 Km/h. However, at the same time, a large frequency offset may improve the accuracy of frequency estimation at UE 102.

In some aspects, UE 102 and/or receiver 114 may include frequency tracking component 110 that compensates for such frequency offsets. In some aspects, for example, UE 102 and/or receiver 114 and/or frequency tracking component 110 include frequency estimator component 118 that performs frequency estimation on downlink signals 108 received from base station 104 so that frequency offsets may be determined and compensated for. Conventionally, the error term in frequency estimate \hat{f} determined by UE 102 and/or receiver 114 and/or frequency tracking component 110 and/or frequency estimator component 118 based on received symbol yₖ may be modeled as:

$$\hat{f} = C {\sum }_{k} k Im ( {z}_{k} )$$

where C is a constant, Im(a) denotes the imaginary part of a, and Zₖ is defined as:

Zₖ=yₖ(\hat{x}ₖ)*

where \hat{x}ₖ is the quadrature phase shift keying (QPSK) hard decision made on yₖ. That is, conventionally, in determining \hat{f}, UE 102 and/or receiver 114 and/or frequency tracking component 110 and/or frequency estimator component 118 use all 44 data symbols in DB1 and DB2 and assume that \hat{x}ₖ is the correct data symbol decision for all k. However, since UE 102 and/or receiver 114 perform channel equalization based on the channel estimate from the midamble, large frequency offsets (e.g., frequency offsets larger than 500 Hz) may severely affect the data symbols at the beginning of DB1 (the data burst before the midamble) and at the end of DB2 (the data burst after the midamble). Thus, the pulling range of the conventional data-aided FTL performed by UE 102 and/or receiver 114 and/or frequency tracking component 110 and/or frequency estimator component 118 may be limited to, e.g., about 500 Hz.

In some present aspects, however, since the reliability of data symbol detection decisions may decrease with the distance from the midamble, UE 102 and/or receiver 114 and/or frequency tracking component 110 and/or frequency estimator component 118 may perform frequency estimation on segments of data defined over DB1 and/or DB2. For example, in some aspects, UE 102 and/or receiver 114 and/or frequency tracking component 110 may include data segmenting component 116 that defines segments of data over DB1 and/or DB2. In some aspects, for example, UE 102 and/or receiver 114 and/or frequency tracking component 110 and/or data segmenting component 116 may determine the data segments (e.g., the location and size of the data segments) based on a look up table. Further, UE 102 and/or receiver 114 and/or frequency tracking component 110 and/or frequency estimator component 118 may include a data segment frequency estimator component 120 that determines a frequency estimate \hat{f}ᵢ based on a data segment Sᵢ as:

$${\hat{f}}_{i} = {C}_{i} {\sum }_{{k}_{i} ∈ {S}_{i}} {k}_{i} Im ( {z}_{{k}_{i}} )$$

where kᵢ is a data index in data segment Sᵢ. In one non-limiting example aspect, data segments Sᵢ (i=1, . . . , m) may be defined such that:
S₁ U S₂ U . . . U Sₘ=[−26:−5] U [5:26]
   S₁ ∩ S₂ ∩ . . . ∩ Sₘ=Ø
      where ∩ denotes intersection and Ø is the null set. That is, in such non-limiting example aspect, the union of data segments Sᵢ is the union of DB1 and DB2, and the intersection of data segments Sᵢ is null.

In some aspects, for example, UE 102 and/or receiver 114 and/or frequency tracking component 110 and/or frequency estimator component 118 may determine a frequency estimate \hat{f} based on frequency estimates \hat{f}ᵢ as:

$$\hat{f} = {\sum }_{i} {w}_{i} {\hat{f}}_{i}$$

where wᵢ is a weight assigned to data segment Sᵢ. For example, in some aspects, UE 102 and/or receiver 114 and/or frequency tracking component 110 and/or frequency estimator component 118 may include a segment weight determiner component 122 that determines such segment weights. In some aspects, for example, UE 102 and/or receiver 114 and/or frequency tracking component 110 and/or frequency estimator component 118 and/or segment weight determiner component 122 may normalize such segment weights.

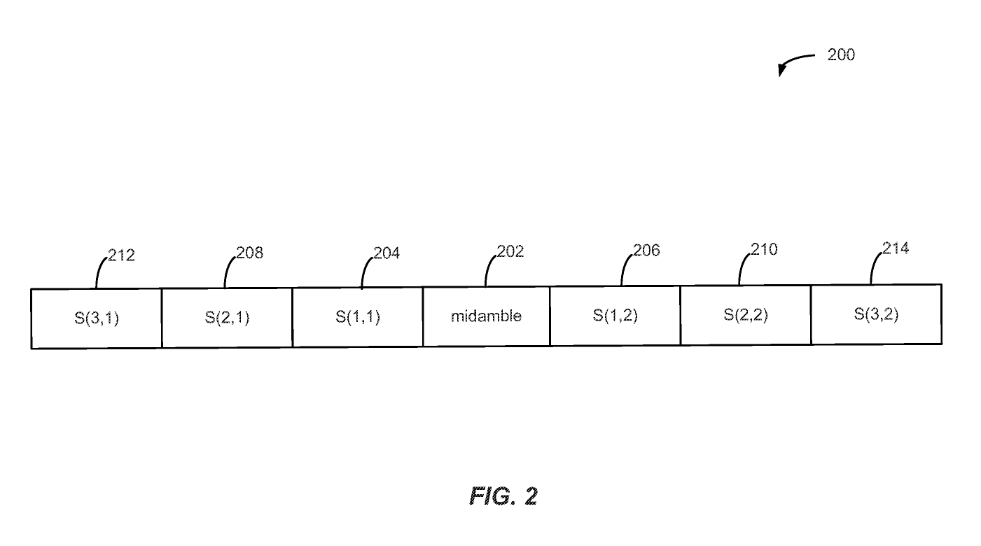

FIG. 2 is a diagram 200 illustrating one non-limiting example aspect of data segments in a downlink TD-SCDMA time slot determined by UE 102 and/or receiver 114 and/or frequency tracking component 110 and/or data segmenting component 116. In FIG. 2, block 202 corresponds to the midamble of a TD-SCDMA downlink time slot. In this non-limiting example aspect, each data segment Sᵢ, where i is a positive integer representing a count of segments away from midamble 202, includes two subsets of symbols on opposite sides of the midamble 202. For example, blocks 204 and 206 respectively correspond to subsets S(1,1) and S(1,2) of data segment S₁. Similarly, blocks 208 and 210 respectively correspond to subsets S(2,1) and S(2,2) of data segment S₂, and blocks 212 and 214 respectively correspond to subsets S(3,1) and S(3,2) of data segment S₃. Accordingly, the downlink TD-SCDMA time slot in diagram 200 includes three data segments S₁, S₂, and S₃.

In the example diagram 200 of FIG. 2, subsets S(1,1) and S(1,2) of data segment S₁ may have the same size. Similarly, subsets S(2,1) and S(2,2) of data segment S₂ may have the same size, and subsets S(3,1) and S(3,2) of data segment S₃ may also have the same size. In one non-limiting example aspect, subsets S(1,1) and S(1,2) of data segment S₁ and subsets S(2,1) and S(2,2) of data segment S₂ may each include 8 data symbols, and subsets S(3,1) and S(3,2) of data segment S₃ may each include 6 data symbols.

Further, based on the example diagram 200 of FIG. 2, UE 102 and/or receiver 114 and/or frequency tracking component 110 and/or frequency estimator component 118 and/or data segment frequency estimator component 120 may perform data-aided frequency estimation separately on each of data segments S₁, S₂, and S₃. In these aspects, UE 102 and/or receiver 114 and/or frequency tracking component 110 and/or frequency estimator component 118 may determine a final frequency estimate as a normalized weighted average of frequency estimates obtained from data segments S₁, S₂, and S₃, using segment weights determined by UE 102 and/or receiver 114 and/or frequency tracking component 110 and/or frequency estimator component 118 and/or segment weight determiner component 122.

In some aspects, for example, UE 102 and/or receiver 114 and/or frequency tracking component 110 and/or frequency estimator component 118 and/or segment weight determiner component 122 may assign a higher weight to a segment (e.g., segment S₁) that is closer to the midamble 202 as compared to a weight assigned to a segment (e.g., segment S₃) that is farther away from midamble 202.

For example, in some aspects, in the presence of high frequency offsets (e.g., on high speed trains or airplanes), UE 102 and/or receiver 114 and/or frequency tracking component 110 and/or frequency estimator component 118 and/or segment weight determiner component 122 may assign the highest segment weight w₁ to data segment S₁ (blocks 204 and 206) which is closest to the midamble 202, assign the lowest segment weight w₃ to segment S₃ (blocks 212 and 214) that is located at the sub-frame boundaries, and assign an intermediate segment weight w₂ to segment S₂ (blocks 208 and 210) that is located in between segment S₁ and segment S₃. For example, in this aspect:
w₁≧w₂≧w₃

In one non-limiting example aspect, the segment weights before normalizing may be:
w₁=3
w₂=2
w₃=1

Optionally, in some aspects, in the presence of low frequency offsets, UE 102 and/or receiver 114 and/or frequency tracking component 110 and/or frequency estimator component 118 and/or segment weight determiner component 122 may assign equal segment weights to all three data segments S₁, S₂, and S₃, due to, for example, a higher reliability of data symbol detection decisions of boundary segment S₃.

In some alternative or additional aspects, for example, UE 102 and/or receiver 114 and/or frequency tracking component 110 and/or frequency estimator component 118 and/or segment weight determiner component 122 may assign a higher weight to data segments that have a relatively higher estimated SNR compared to other data segments that have a relatively lower estimated SNR. In some alternative or additional aspects, UE 102 and/or receiver 114 and/or frequency tracking component 110 and/or frequency estimator component 118 and/or segment weight determiner component 122 may filter the estimated SNR of each data segment (for example, with a first order filter) to determine finer SNR estimates.

For example, in some aspects, when data segments S₁, S₂, and S₃ have no frequency offset, they experience a same estimated SNR. Accordingly, in these aspects, in one non-limiting example, UE 102 and/or receiver 114 and/or frequency tracking component 110 and/or frequency estimator component 118 and/or segment weight determiner component 122 may assign a same weight to data segments S₁, S₂, and S₃.

Alternatively, for example, in some aspects, when data segments S₁, S₂, and S₃ have different frequency offsets, they may have different estimated SNRs. Accordingly, in these aspects, in one non-limiting example, UE 102 and/or receiver 114 and/or frequency tracking component 110 and/or frequency estimator component 118 and/or segment weight determiner component 122 may assign different weights to data segments S₁, S₂, and S₃ based on their respective estimated SNRs. For example, in some aspects, when data segment S₁ has a better estimated SNR than data segment S₃, UE 102 and/or receiver 114 and/or frequency tracking component 110 and/or frequency estimator component 118 and/or segment weight determiner component 122 may assign a higher weight to data segment S₁ compared to data segment S₃.

Accordingly, in these aspects, by adaptively adjusting respective segment weights based on respective estimated SNRs of respective data segments, a better performance may be achieved. For example, in some aspects, when there is no frequency offset, a relatively good root mean square error (RMSE) performance may be achieved by using equal data segment weights, while providing a relatively small pulling range (e.g., about 500 Hz). However, in these aspects, for example, when a high frequency offset occurs, by adaptively adjusting the segment weights based on respective estimated SNRs of data segments, the RMSE performance may be somewhat degraded while compensating for the frequency offset and providing a relatively high pulling range (e.g., about 1000 Hz).

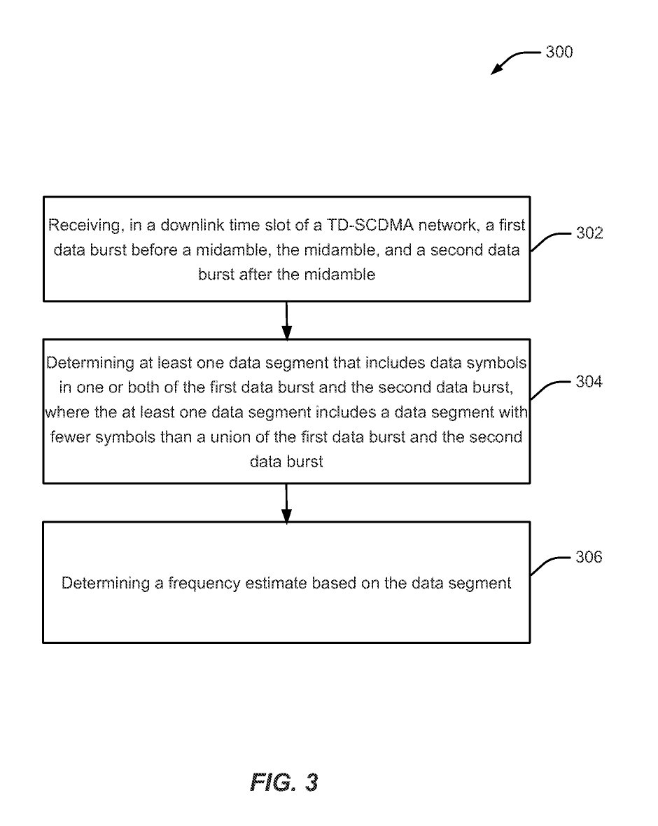

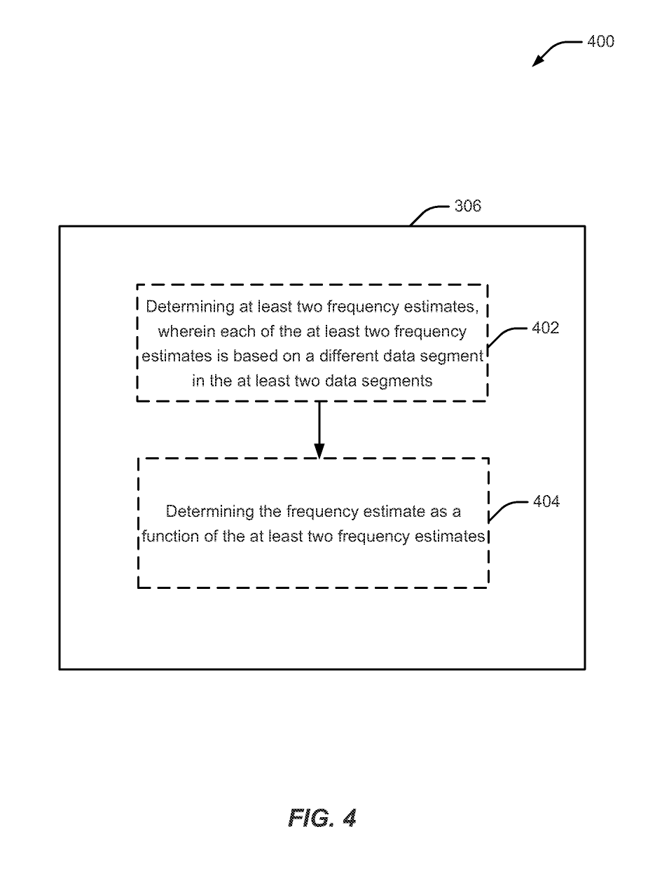

FIGS. 3 and 4 describe methods 300 and 400, respectively, in aspects of the wireless communications system of FIG. 1. For example, methods 300 and 400 may be performed by UE 102 executing receiver 114 and/or frequency tracking component 110 (FIG. 1) as described herein, where method 300 relates to an aspect of data-aided frequency estimation in TD-SCDMA, and method 400 relates to an aspect of determining the frequency estimate.

Referring now to FIG. 3, in an aspect of a method of data-aided frequency estimation in TD-SCDMA in which receiver 114 and/or frequency tracking component 110 perform data-aided frequency estimation, at block 302, method 300 includes receiving, in a downlink time slot of a TD-SCDMA network, a first data burst before a midamble, the midamble, and a second data burst after the midamble. For example, in some aspects, UE 102 and/or receiver 114 may receive, in a downlink time slot of TD-SCDMA network 112, a first data burst before a midamble, the midamble, and a second data burst after the midamble.

At block 304, method 300 includes determining at least one data segment that includes data symbols in one or both of the first data burst and the second data burst, where the at least one data segment includes a data segment with fewer symbols than a union of the first data burst and the second data burst. For example, in some aspects, UE 102 and/or receiver 114 and/or frequency tracking component 110 and/or data segmenting component 116 may determine at least one data segment that includes data symbols in one or both of the first data burst and the second data burst, where the at least one data segment includes a data segment with fewer symbols than a union of the first data burst and the second data burst, as described herein with reference to FIG. 2. For example, in some aspects, UE 102 and/or receiver 114 and/or frequency tracking component 110 and/or data segmenting component 116 may determine the data segment according to a look up table.

Optionally, in some aspects, the data segment may include a first subset of data symbols before the midamble and a second subset of data symbols after the midamble, as described herein with reference to FIG. 2.

Optionally, in some aspects, the first subset of data symbols and the second subset of data symbols include a same number of consecutive data symbols, as described herein with reference to FIG. 2.

Optionally, in some aspects, the first subset of data symbols and the second subset of data symbols are equally distanced from the midamble, as described herein with reference to FIG. 2.

Optionally, in some aspects, the data segment may include either a first subset of data symbols before the midamble or a second subset of data symbols after the midamble. For example, in one non-limiting example, the frequency estimate may be determined based on either a first subset of data symbols before the midamble or a second subset of data symbols after the midamble. For example, in some aspects, the frequency estimate may be determined based on a subset of data symbols in DB1 only. Alternatively, for example, in some aspects, the frequency estimate may be determined based on a subset of data symbols in DB2 only.

At block 306, method 300 includes determining a frequency estimate based on the data segment. For example, in some aspects, UE 102 and/or receiver 114 and/or frequency tracking component 110 and/or frequency estimator component 118 may determine a frequency estimate based on the data segment. For example, in some aspects, UE 102 and/or receiver 114 and/or frequency tracking component 110 and/or frequency estimator component 118 may separately determine a data segment frequency estimate based on each data segment, and then determine a frequency estimate as a function of the data segment frequency estimates, e.g., as a weighted sum of the data segment frequency estimates.

Referring to FIG. 4, method 400 includes further, and optional, aspects related to block 306 of method 300 of FIG. 3 for determining a frequency estimate based on at least two data segments.

At optional block 402, method 400 includes determining at least two frequency estimates, where each of the at least two frequency estimates is based on a different data segment in the at least two data segments. For example, in some aspects, UE 102 and/or receiver 114 and/or frequency tracking component 110 and/or frequency estimator component 118 and/or data segment frequency estimator component 120 may determine at least two frequency estimates, where each of the at least two frequency estimates is based on a different data segment in the at least two data segments.

At optional block 404, method 400 includes determining the frequency estimate as a function of the at least two frequency estimates. For example, in some aspects, UE 102 and/or receiver 114 and/or frequency tracking component 110 and/or frequency estimator component 118 may determine the frequency estimate as a function of the at least two frequency estimates.

Optionally, in some aspects, the function is a weighted sum of the at least two frequency estimates, as described herein with reference to FIG. 2.

Optionally, in some aspects, in the weighted sum, a weight given to a respective frequency estimate that is based on a respective data segment is a function of a distance of the respective data segment from the midamble, as described herein with reference to FIG. 2.

Optionally, in some aspects, in the weighted sum, a first frequency estimate related to a first data segment has a higher weight than a second frequency estimate related to a second data segment when a first distance of the first data segment from the midamble is less than a second distance of the second data segment from the midamble, as described herein with reference to FIG. 2.

Optionally, in some aspects, in the weighted sum, a weight given to a respective frequency estimate that is based on a respective data segment is a function of an estimated SNR of the respective data segment.

Optionally, in some aspects, in the weighted sum, a first frequency estimate related to a first data segment has a higher weight than a second frequency estimate related to a second data segment when a first estimated SNR of the first data segment is higher than a second estimated SNR of the second data segment.

Accordingly, in some present aspects, by segmenting data symbols (received in a TD-SCDMA downlink time slot) based on the reliability of data symbol detection decisions, and performing frequency estimation based on the resulting data segments, the pulling range of data-aided FTL may be improved. In some present aspects, by segmenting data symbols into data segments and determining a frequency estimate as a function of individual frequency estimates of different data segments, a tradeoff is achieved between the higher accuracy of frequency estimates of data symbols that are far from the midamble and the lower frequency offset of data symbols that are closer to the midamble. Some present aspects further provide a shorter transient time in frequency tracking/estimation.

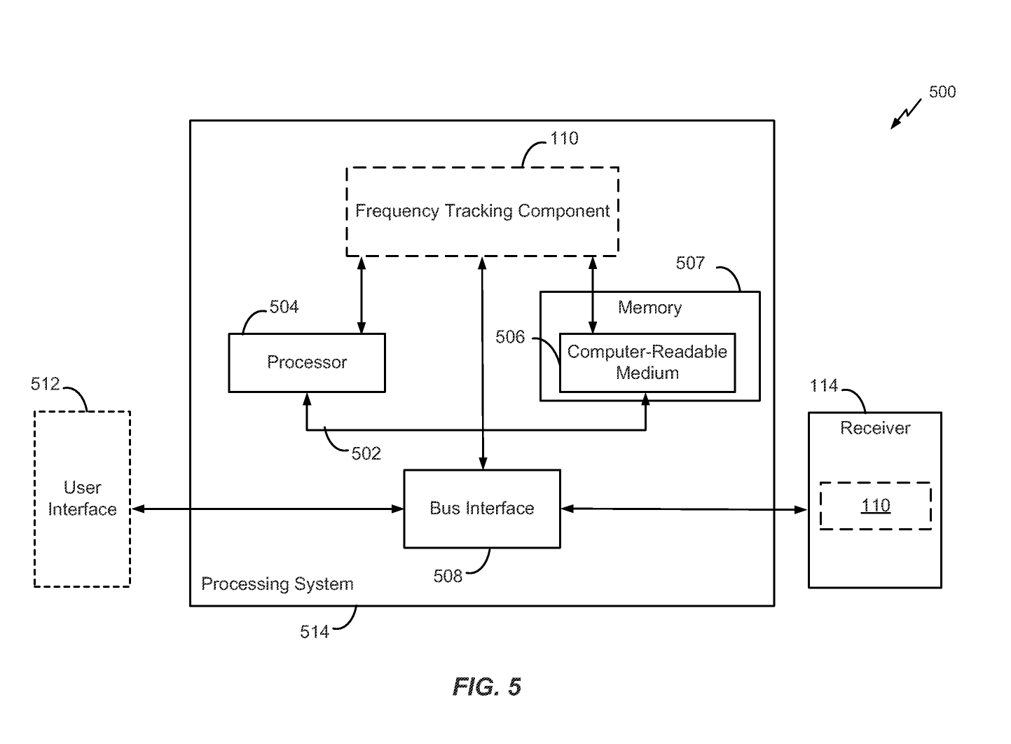

Referring to FIG. 5, an example of a hardware implementation for an apparatus 500 including frequency tracking component 110 and employing a processing system 514 is shown. In an aspect, apparatus 500 may be UE 102 of FIG. 1, including receiver 114, and may be configured to perform any functions described herein with reference to UE 102 and/or receiver 114 and/or frequency tracking component 110. In this aspect, frequency tracking component 110 may be a component of receiver 114, or optionally may be implemented in processing system 514 separate from, but in communication with, receiver 114. Further, in this aspect, frequency tracking component 110 may be implemented as one or more processor modules in a processor 504 of UE 102, as computer-readable instructions stored in a computer-readable medium 506 in a memory 507 of UE 102 and executed by processor 504 of UE 102, or some combination of both. Further, in an aspect, processing system 514 may be implemented as a part of receiver 114.

In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors, represented generally by the processor 504, one or more communications components, such as, for example, frequency tracking component 110 of FIG. 1, and computer-readable media, represented generally by the computer-readable medium 506. The bus 502 may also link various other circuits such as timing sources, peripherals, voltage regulators, and power management circuits, which are well known in the art, and therefore, will not be described any further. A bus interface 508 provides an interface between the bus 502 and receiver 114, which may be part of a transceiver (not shown). The receiver 114 and/or transceiver (not shown) provide a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software stored on the computer-readable medium 506. For example, in some aspects, joint channel estimator and non-linear symbol detector component 110 may be software stored on the computer-readable medium 506 and may be executed by processor 504. The software, when executed by the processor 504, causes the processing system 514 to perform the various functions described herein for any particular apparatus.

The computer-readable medium 506 may also be used for storing data that is manipulated by the processor 504 when executing software, such as, for example, software modules represented by frequency tracking component 110. In one example, the software modules (e.g., any algorithms or functions that may be executed by processor 504 to perform the described functionality) and/or data used therewith (e.g., inputs, parameters, variables, and/or the like) may be retrieved from computer-readable medium 506. The modules may be software modules running in the processor 504, resident and/or stored in the computer-readable medium 506, one or more hardware modules coupled to the processor 504, or some combination thereof.

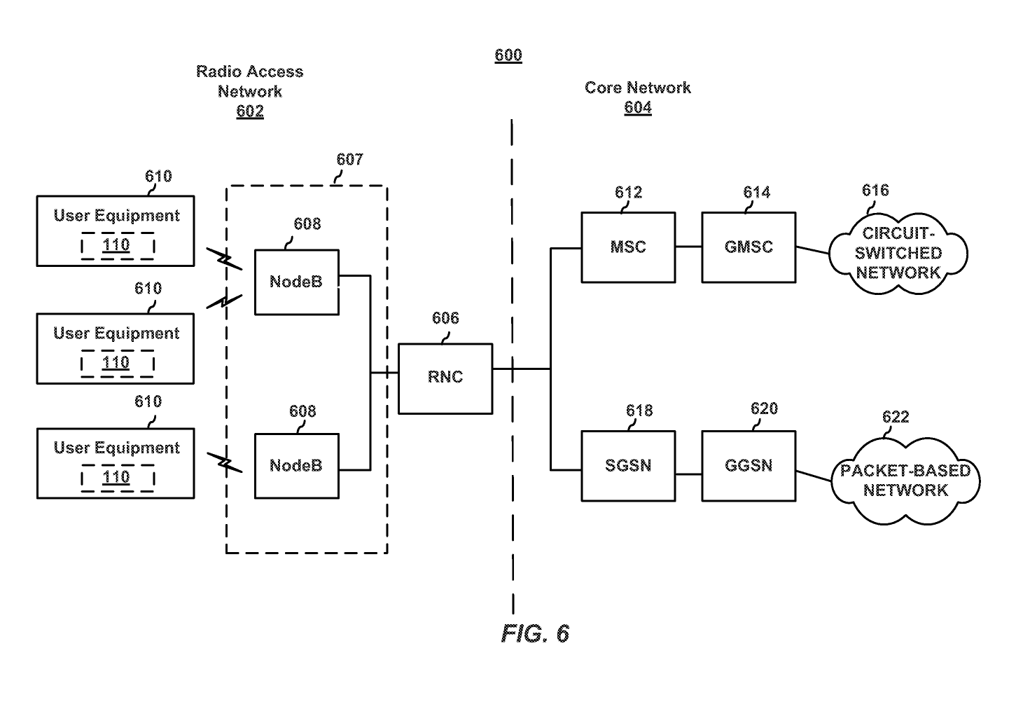

Turning now to FIG. 6, a block diagram is shown illustrating an example of a telecommunications system 600. Telecommunications system 600 includes UEs 610 which may be examples of UE 102 of FIG. 1 and which may include and execute frequency tracking component 110 to perform any functions described herein. The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system employing a TD-SCDMA standard. In this example, the UMTS system includes a (radio access network) RAN 602 (e.g., UTRAN) that provides various wireless services including telephony, video, data, messaging, broadcasts, and/or other services. The RAN 602 may be divided into a number of Radio Network Subsystems (RNSs) such as an RNS 607, each controlled by a Radio Network Controller (RNC) such as an RNC 606. For clarity, only the RNC 606 and the RNS 607 are shown; however, the RAN 602 may include any number of RNCs and RNSs in addition to the RNC 606 and RNS 607. The RNC 606 is an apparatus responsible for, among other things, assigning, reconfiguring and releasing radio resources within the RNS 607. The RNC 606 may be interconnected to other RNCs (not shown) in the RAN 602 through various types of interfaces such as a direct physical connection, a virtual network, or the like, using any suitable transport network.

The geographic region covered by the RNS 607 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 608 are shown; however, the RNS 607 may include any number of wireless Node Bs. The Node Bs 608 provide wireless access points to a core network 604 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 610, which may be the same as or similar to UE 102 of FIG. 1, are shown in communication with the Node Bs 608, which may be the same as or similar to base station 104 of FIG. 1. The downlink (DL), also called the forward link, refers to the communication link from a Node B to a UE, and the uplink (UL), also called the reverse link, refers to the communication link from a UE to a Node B.

The core network 604, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 604 supports circuit-switched services with a mobile switching center (MSC) 612 and a gateway MSC (GMSC) 614. One or more RNCs, such as the RNC 606, may be connected to the MSC 612. The MSC 612 is an apparatus that controls call setup, call routing, and UE mobility functions. The MSC 612 also includes a visitor location register (VLR) (not shown) that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR to determine the UE's location and forwards the call to the particular MSC serving that location.

The core network 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard GSM circuit-switched data services. The GGSN 620 provides a connection for the RAN 602 to a packet-based network 622. The packet-based network 622 may be the Internet, a private data network, or some other suitable packet-based network. The primary function of the GGSN 620 is to provide the UEs 610 with packet-based network connectivity. Data packets are transferred between the GGSN 620 and the UEs 610 through the SGSN 618, which performs primarily the same functions in the packet-based domain as the MSC 612 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 608 and a UE 610, but divides uplink and downlink transmissions into different time slots in the carrier.

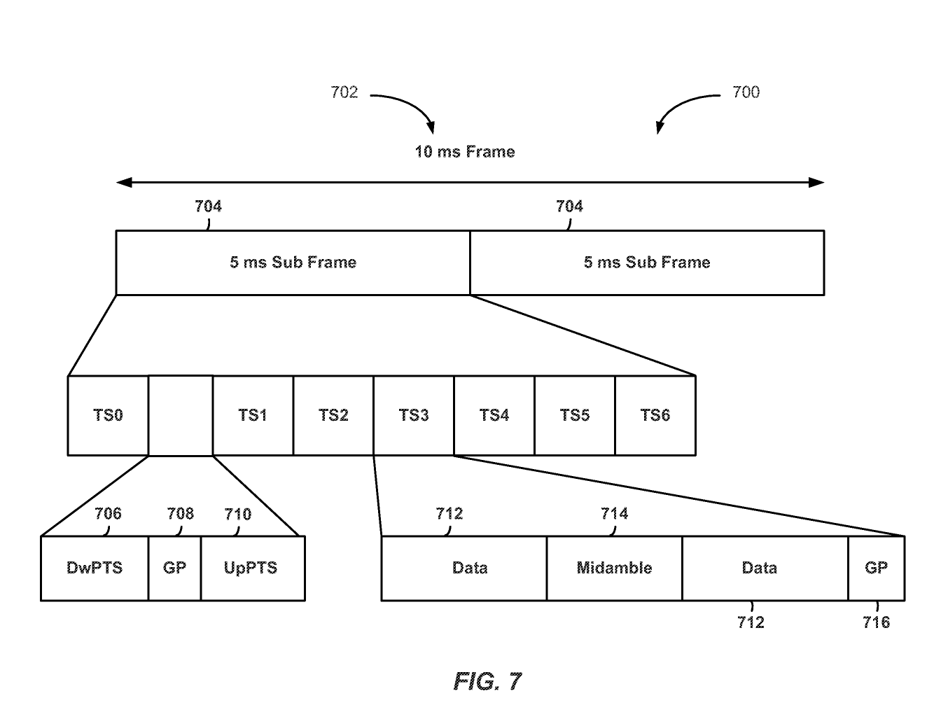

FIG. 7 shows a frame structure 700 for a TD-SCDMA carrier, which may be used for communications between base station 104 of FIG. 1, and UE 102, also of FIG. 1. The TD-SCDMA carrier, as illustrated, has a frame 702 that is 10 milliseconds (ms) in duration. The frame 702 has two 5 ms subframes 704, and each of the subframes 704 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 706, a guard period (GP) 708, and an uplink pilot time slot (UpPTS) 710 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 712 separated by a midamble 714 and followed by a guard period (GP) 716. The midamble 714 may be used for features, such as channel estimation, while the GP 716 may be used to avoid inter-burst interference.

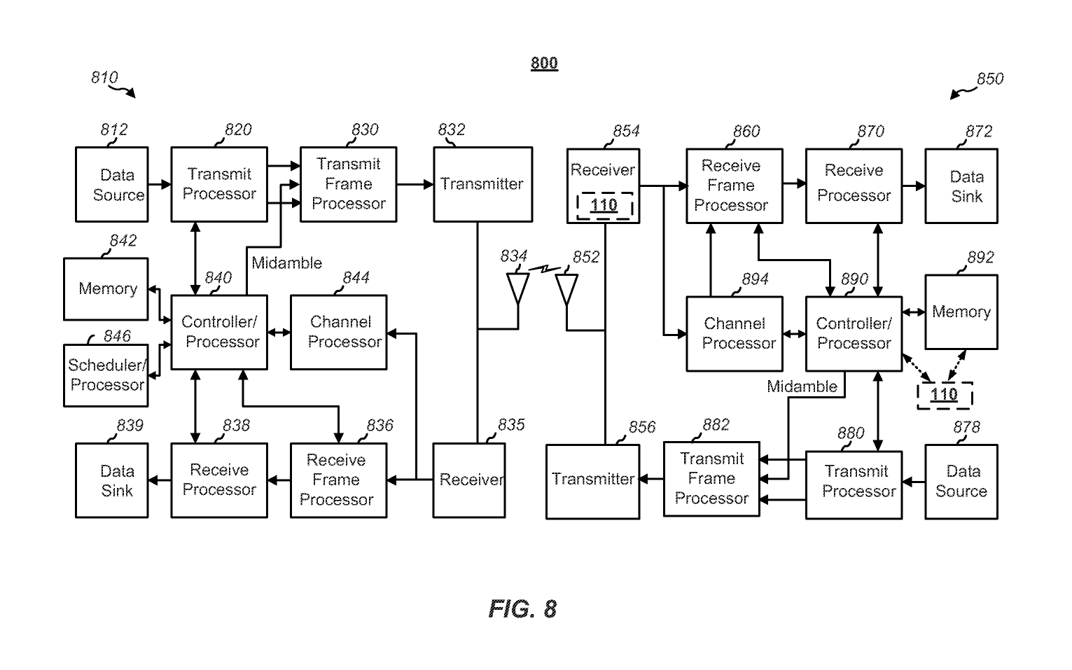

FIG. 8 is a block diagram of a Node B 810 in communication with a UE 850 in a RAN 800. In an aspect, Node B 810 may be an example of base station 104 of FIG. 1, and UE 850 may be an example of UE 102 of FIG. 1 and may include and execute frequency tracking component 110 of FIG. 1, either in receiver 854 (which may be the same as or equivalent to receiver 114 of FIG. 1) or optionally separate from receiver 854, for example, in memory 892 and/or controller/processor 890, to perform any functions described herein.

In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback contained in the midamble 714 (FIG. 7) from the UE 850. The symbols generated by the transmit processor 820 are provided to a transmit frame processor 830 to create a frame structure. The transmit frame processor 830 creates this frame structure by multiplexing the symbols with a midamble 714 (FIG. 7) from the controller/processor 840, resulting in a series of frames. The frames are then provided to a transmitter 832, which provides various signal conditioning functions including amplifying, filtering, and modulating the frames onto a carrier for downlink transmission over the wireless medium through smart antennas 834. The smart antennas 834 may be implemented with beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides the midamble 714 (FIG. 7) to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with a midamble 714 (FIG. 7) from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides the midamble 714 (FIG. 7) to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

The present aspects may be implemented in a computer-readable media storing computer executable code to perform the functions described herein. Such a computer-readable media may be non-transitory, and/or may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), whichever is appropriate, unless the element is expressly recited using the phrase “means for” or, in the case of a method claim, the element is recited using the phrase “step for.”

What is claimed is:

1. A method of data-aided frequency estimation in time division synchronous code division multiple access (TD-SCDMA), comprising:
receiving, in a downlink time slot of a TD-SCDMA network, a first data burst before a midamble, the midamble, and a second data burst after the midamble;
determining at least one data segment that includes data symbols in one or both of the first data burst and the second data burst, wherein the at least one data segment includes a data segment with fewer symbols than a union of the first data burst and the second data burst; and
determining a frequency estimate based on the data segment.

2. The method of claim 1, wherein the data segment comprises a first subset of data symbols before the midamble and a second subset of data symbols after the midamble, wherein the first subset of data symbols and the second subset of data symbols include a same number of consecutive data symbols, wherein the first subset of data symbols and the second subset of data symbols are equally distanced from the midamble.

3. The method of claim 1, wherein the data segment comprises either a first subset of data symbols before the midamble or a second subset of data symbols after the midamble.

4. The method of claim 1, wherein the at least one data segment comprises at least two data segments, wherein the determining of the frequency estimate includes:
determining at least two frequency estimates, wherein each of the at least two frequency estimates is based on a different data segment in the at least two data segments; and
determining the frequency estimate as a function of the at least two frequency estimates.

5. The method of claim 4, wherein the function is a weighted sum of the at least two frequency estimates.

6. The method of claim 4, wherein in the weighted sum, a weight given to a respective frequency estimate that is based on a respective data segment is a function of a distance of the respective data segment from the midamble.

7. The method of claim 4, wherein in the weighted sum, a first frequency estimate related to a first data segment has a higher weight than a second frequency estimate related to a second data segment when a first distance of the first data segment from the midamble is less than a second distance of the second data segment from the midamble.

8. The method of claim 4, wherein in the weighted sum, a weight given to a respective frequency estimate that is based on a respective data segment is a function of an estimated signal to noise ratio (SNR) of the respective data segment.

9. The method of claim 4, wherein in the weighted sum, a first frequency estimate related to a first data segment has a higher weight than a second frequency estimate related to a second data segment when a first estimated signal to noise ratio (SNR) of the first data segment is higher than a second estimated SNR of the second data segment.

10. An apparatus for data-aided frequency estimation in time division synchronous code division multiple access (TD-SCDMA), comprising:
a receiver configured to receive, in a downlink time slot of a TD-SCDMA network, a first data burst before a midamble, the midamble, and a second data burst after the midamble;
a data segmenting component configured to determine at least one data segment that includes data symbols in one or both of the first data burst and the second data burst, wherein the at least one data segment includes a data segment with fewer symbols than a union of the first data burst and the second data burst; and
a frequency estimator component configured to determine a frequency estimate based on the data segment.

11. The apparatus of claim 10, wherein the data segment comprises a first subset of data symbols before the midamble and a second subset of data symbols after the midamble, wherein the first subset of data symbols and the second subset of data symbols include a same number of consecutive data symbols, wherein the first subset of data symbols and the second subset of data symbols are equally distanced from the midamble.

12. The apparatus of claim 10, wherein the data segment comprises either a first subset of data symbols before the midamble or a second subset of data symbols after the midamble.

13. The apparatus of claim 10, wherein the at least one data segment comprises at least two data segments, wherein to determine the frequency estimate, the frequency estimator is configured to:
determine at least two frequency estimates, wherein each of the at least two frequency estimates is based on a different data segment in the at least two data segments; and
determine the frequency estimate as a function of the at least two frequency estimates.

14. The apparatus of claim 13, wherein the function is a weighted sum of the at least two frequency estimates.

15. The apparatus of claim 14, wherein in the weighted sum, a weight given to a respective frequency estimate that is based on a respective data segment is a function of a distance of the respective data segment from the midamble.

16. The apparatus of claim 14, wherein in the weighted sum, a first frequency estimate related to a first data segment has a higher weight than a second frequency estimate related to a second data segment when a first distance of the first data segment from the midamble is less than a second distance of the second data segment from the midamble.

17. The apparatus of claim 14, wherein in the weighted sum, a weight given to a respective frequency estimate that is based on a respective data segment is a function of an estimated signal to noise ratio (SNR) of the respective data segment.

18. The apparatus of claim 14, wherein in the weighted sum, a first frequency estimate related to a first data segment has a higher weight than a second frequency estimate related to a second data segment when a first estimated signal to noise ratio (SNR) of the first data segment is higher than a second estimated SNR of the second data segment.

19. An apparatus for data-aided frequency estimation in time division synchronous code division multiple access (TD-SCDMA), comprising:
means for receiving, in a downlink time slot of a TD-SCDMA network, a first data burst before a midamble, the midamble, and a second data burst after the midamble;
means for determining at least one data segment that includes data symbols in one or both of the first data burst and the second data burst, wherein the at least one data segment includes a data segment with fewer symbols than a union of the first data burst and the second data burst; and
means for determining a frequency estimate based on the data segment.

20. The apparatus of claim 19, wherein the data segment comprises a first subset of data symbols before the midamble and a second subset of data symbols after the midamble, wherein the first subset of data symbols and the second subset of data symbols include a same number of consecutive data symbols, wherein the first subset of data symbols and the second subset of data symbols are equally distanced from the midamble.

21. The apparatus of claim 19, wherein the data segment comprises either a first subset of data symbols before the midamble or a second subset of data symbols after the midamble.

22. The apparatus of claim 19, wherein the at least one data segment comprises at least two data segments, wherein to determine the frequency estimate, the means for determining the frequency estimate includes:
means for determining at least two frequency estimates, wherein each of the at least two frequency estimates is based on a different data segment in the at least two data segments; and
means for determining the frequency estimate as a function of the at least two frequency estimates.

23. The apparatus of claim 22, wherein the function is a weighted sum of the at least two frequency estimates.

24. The apparatus of claim 23, wherein in the weighted sum, a weight given to a respective frequency estimate that is based on a respective data segment is a function of a distance of the respective data segment from the midamble.

25. The apparatus of claim 23, wherein in the weighted sum, a first frequency estimate related to a first data segment has a higher weight than a second frequency estimate related to a second data segment when a first distance of the first data segment from the midamble is less than a second distance of the second data segment from the midamble.

26. The apparatus of claim 23, wherein in the weighted sum, a weight given to a respective frequency estimate that is based on a respective data segment is a function of an estimated signal to noise ratio (SNR) of the respective data segment.

27. The apparatus of claim 23, wherein in the weighted sum, a first frequency estimate related to a first data segment has a higher weight than a second frequency estimate related to a second data segment when a first estimated signal to noise ratio (SNR) of the first data segment is higher than a second estimated SNR of the second data segment.

28. A computer-readable medium storing computer executable code for data-aided frequency estimation in time division synchronous code division multiple access (TD-SCDMA), comprising:
code for receiving, in a downlink time slot of a TD-SCDMA network, a first data burst before a midamble, the midamble, and a second data burst after the midamble;
code for determining at least one data segment that includes data symbols in one or both of the first data burst and the second data burst, wherein the at least one data segment includes a data segment with fewer symbols than a union of the first data burst and the second data burst; and
code for determining a frequency estimate based on the data segment.

29. The computer-readable medium of claim 28, wherein the data segment comprises a first subset of data symbols before the midamble and a second subset of data symbols after the midamble, wherein the first subset of data symbols and the second subset of data symbols include a same number of consecutive data symbols, wherein the first subset of data symbols and the second subset of data symbols are equally distanced from the midamble.

30. The computer-readable medium of claim 28, wherein the data segment comprises either a first subset of data symbols before the midamble or a second subset of data symbols after the midamble.
